(19) United States
(12) Patent Application Publication
(10) Pub. No.: US 2007/0244234 A1
(43) Pub. Date: Oct. 18, 2007

(54) Durable and Low Friction Thermoplastic Elastomer Compositions

(75) Inventor: Ashok M. Adur, Westlake, OH (US)

Correspondence Address: POLYONE CORPORATION, 33587 WALKER ROAD, AVON LAKE, OH, 44012, US

(73) Assignee: PolyOne Corporation, Avon Lake, OH (US)

(21) Appl. No.: 11/570,412

(22) PCT Filed: Jun. 10, 2005
(86) PCT No.: PCT/US05/20613

§ 371 Date: Dec. 11, 2006

Related U.S. Application Data
(60) Provisional application No. 60/579,222, filed on Jun. 14, 2004.

(51) Int. Cl. C08K 9/06; C08L 23/16

(52) U.S. Cl. 524/261

(57) ABSTRACT

A thermoplastic elastomer composition is disclosed, comprising at least one thermoplastic elastomer, a minor amount of at least one high molecular weight polydialkylsiloxane, and a minor amount of at least one fluoropolymer. Compositions of the invention have improved durability by virtue of their improved resistance to scratching and marring. Further, compositions of the invention are beneficially low friction as evidenced by a reduced coefficient of friction as compared to unmodified thermoplastic elastomers.

### CLAIM OF PRIORITY

This application claims priority from U.S. Provisional Patent Application Ser. No. 60/579,222 bearing Attorney Docket Number 12003012 and filed on Jun. 14, 2004.

### BACKGROUND OF THE INVENTION

In the past several decades, the use of polymers has transformed the world. Polymer science has rapidly evolved to make thousands of different thermoplastic and thermosetting products within the four corners of polymer physics: thermoplastic plastics, thermoplastic elastomers, thermoset plastics, and thermoset elastomers.

No large scale production of any polymer can rest on current ingredients or processing conditions. Reduction of cost, improvement of productivity, delivery of better performing, lower cost products all drive the polymer science industry. The situation is no different for the thermoplastic elastomer (TPE) industry.

Scratch and mar resistance is an important performance criterion for many applications requiring durability. One factor preventing the widespread use of TPEs in such applications, however, is the fact that articles made from TPE compositions are often more prone to damage from scratching or marring due to their soft nature. Articles made from polymeric compositions that provide scratch and mar resistance are desired for use, in among other things, applications of this type.

While certain improvements in scratch and mar resistance properties of thermoplastics have been reported, it has not yet been known how to effectively formulate TPE compositions with sufficient scratch and mar resistance for many applications requiring durability. One of the reasons for this problem is that the addition of typical components for improving scratch and mar resistance of a material tend to unduly increase the hardness of the material such that it does not retain its rubbery (i.e., elastomeric) properties required to classify the material as a TPE.

Another desirable performance criterion for many applications, even those requiring durability, is relatively low friction (i.e., as measured by a material's coefficient of friction (COF), whether it be static and/or kinematic friction). Many applications calling for rubbery properties associated with TPEs, such as automotive window sealing applications, benefit not only from durable materials with scratch/mar-resistant surfaces, but also from materials imparting relatively low friction in the dynamic environments in which they are designed for use. For example, when used adjacent to hard materials (e.g., a glass window or metal door frame) in such an application, it is desirable for a sealant material to allow easy gliding of the hard material across the surface of the sealant material (e.g., when opening or closing a window employing such a sealant).

In particular, TPEs having a combination of low friction (as measured by the material's coefficient of friction) along with durability against scratches and mars are desirable. Effective formulation of TPEs of that type would open up the possibility for use of TPEs in many new applications that were hitherto not possible.

### BRIEF SUMMARY OF THE INVENTION

What is needed is a TPE that is made durable, resisting scratching and marring, without increasing hardness of the TPE significantly. One advantage of the present invention is the ability to improve scratch and mar resistance of the TPE without detrimentally increasing hardness of the composition. This is an improvement over that typically associated with the conventional use of, for example, nanoclays for the same purpose. When hardness of the composition increases, it can detrimentally affect the composition's ability to function as a TPE.

What is further needed is a TPE that is not only durable, but also provides low friction (whether it is static or kinematic friction) against surfaces in which it is in contact during utilization. Another advantage of this invention is the ability to reduce the coefficient of friction associated with articles made from compositions of the invention. Thus, not only will the TPEs exhibit improved durability through their scratch and mar resistance, but they will also exhibit low friction as evidenced by their relatively low coefficient of friction (i.e., increased lubricity) in certain embodiments. This beneficially enables use of TPEs of the invention in applications such as those employing dynamic sealing. Dynamic sealing assists in providing automotive weather seals, where low friction against glass surfaces is important.

In meeting these needs and expanding the ability to effectively and advantageously use thermoplastic elastomers, thermoplastic elastomer compositions of the invention comprise at least one thermoplastic elastomer, a minor amount of at least one high molecular weight polydialkylsiloxane, and a minor amount of at least one fluoropolymer. Such compositions also include less than 0.5 parts by weight of polydialkylsiloxane having a melt viscosity of 1,000,000 centistokes or less when measured at 25° C., materials which if present can deteriorate the performance of the otherwise improved TPE compositions. Many features and advantages of the present invention will become apparent from disclosure of the embodiments and examples of the invention below.

### DETAILED DESCRIPTION OF THE INVENTION

This invention relates to improved thermoplastic elastomer compositions that exhibit a combination of durability (i.e., scratch and mar resistance) and low friction (i.e., lubricity).

### DEFINITIONS

A “thermoplastic elastomer” (TPE) is generally a polymer or blend of polymers that can be processed and recycled in the same way as a conventional thermoplastic material, yet having properties and performance similar to that of an elastomer or rubber at the service temperature at which it is used. Notably, blends (or alloys) of plastic and elastomeric rubber have become increasingly important in the production of TPEs, particularly for the replacement of thermoset rubber or flexible polyvinyl chloride (PVC) in various applications.

A “thermoplastic vulcanizate” (TPV) is a type of TPE, where the elastomeric phase is partially or completely crosslinked, vulcanized or cured, such that the TPV can be processed and recycled in the same way as a conventional thermoplastic material, yet retaining properties and performance similar to that of a vulcanized elastomer or rubber at the service, temperature at which it is used. TPVs are becoming increasingly important in the production of high performance TPEs, particularly for the replacement of thermoset rubber in various applications.

For purposes of this invention, “high molecular weight polydialkylsiloxane” (including, e.g., “high molecular weight polydimethylsiloxane”) refers to silicone-containing polymers that are solid at room temperature. In contrast, for example, silicone oils are liquid at room temperature. Generally, high molecular weight polydialkylsiloxane polymers of the invention have a melt viscosity of greater than 1,000,000 centistokes when measured at 25° C. Preferably, the polymers have a melt viscosity of at least about 5,000,000, more preferably about 5,000,000 to about 20,000,000, and even more preferably about 10,000,000 to about 20,000,000 centistokes, when measured at 25° C. Those of ordinary skill in the art will recognize, however, that polydialkylsiloxane polymers with molecular weights above the upper limit of this preferred range can also be used in accordance with the invention. Use of polydialkylsiloxane polymers with lower molecular weights, however, should be limited for reasons described further below.

For purposes of this invention, “minor amount” means about 0.01 to about 50 percent based on total weight of the composition. TPE compositions of the invention include a minor amount of each of a high molecular weight polydialkylsiloxane polymer and a fluoropolymer. Each of those components has more preferred ranges as set forth below, which are within this broader definition of minor amount.

TPE Compositions

A wide variety of TPE compositions benefit from the combined addition of a minor amount of a high molecular weight polydialkylsiloxane and fluoropolymer according to the present invention. TPE compositions of the invention comprise at least one thermoplastic elastomer, a minor amount of at least one high molecular weight polydialkylsiloxane, and a minor amount of at least one fluoropolymer. Such compositions also include less than 0.5 parts by weight of polydialkylsiloxane having a melt viscosity of 1,000,000 centistokes or less when measured at 25° C., materials which if present can deteriorate the performance of the otherwise improved TPE compositions.

The elastomeric phase within the TPE can be partially or completely vulcanized. Thus, the TPE composition may be a TPV. In further embodiments, TPE compositions may also comprise optional processing oils, other additives, or combinations thereof.

Advantageously, TPE compositions of the invention provide beneficial improvements in durability and low friction without a detrimental increase in hardness. It is known that TPEs are characterized by their rubber-like performance. As hardness increases, rubber-like performance typically decreases, which is not desirable for many applications. For example, as hardness of a TPE increases, the ability of the TPE to provide an effective seal and the composition's resiliency decreases. Under extreme circumstances, very hard TPEs have no more than minimal rubber-like properties and are unusable for applications requiring resiliency.

Hardness values for TPEs of the invention can be measured using a wide variety of suitable equipment and methodology. For example, hardness can be measured using a test such as that described in ASTM D2240, wherein Shore A and Shore D values can be obtained using an indentation hardness tester. The Shore A and D scales overlap. Preferably, however, TPEs of the invention exhibit Shore A hardness values ranging from about 0 Shore A to about 95 Shore A. Also preferred are TPEs that exhibit Shore D hardness values ranging from about 0 Shore D to about 70 Shore D.

Thermoplastic Elastomer (TPE)

Any suitable TPE can be used as the base component of the invention. Details of particularly preferred TPEs are provided below. It should be understood, however, that compositions of the invention are not limited to those based on certain types of TPEs. Further understand that the TPEs may be prepared from thermoplastic and elastomer components according to known methods or the TPEs may be obtained already obtained from a commercial supplier prior to incorporation of the polydialkylsiloxane therein. A wide variety of base TPE compositions are commercially available. For example, Polyone Corporation, Bayer, DSM, Crompton Corporation, DuPont Dow Elastomers, Solvay, Teknor Apex, Applied Elastomer Systems, Multibase, SoFTeR, Sumitomo Chemical, Asahi Kasei, Kraton, GLS, ExxonMobil Corporation, Uniroyal Chemical, and many other multinational companies have supplied commercial TPEs to the marketplace using a variety of trade designations. The individual thermoplastic and elastomer components within those TPEs and those for use in preparing other TPEs are described more fully below.

One particularly preferred TPE is a thermoplastic olefin elastomer (TPE-O), which TPEs comprise at least one thermoplastic polyolefin and at least one elastomer. Other TPEs useful according to the invention include, for example, those based on styrenic or nitrile rubbers.

Any suitable thermoplastic material may be used as the thermoplastic component of TPEs of the invention. Thermoplastics are generally materials that can be molded or otherwise shaped and reprocessed at temperatures at least as great as their softening or melting point.

Polyolefins are preferred thermoplastic materials, particularly when TPE-Os are desired. Polyolefins are a fundamental building block in polymer science and engineering because of their low cost, high volume production based on petrochemical production.

Non-limiting examples of polyolefins useful as thermoplastic olefins of the invention include homopolymers and copolymers of lower α-olefins such as 1-butene, 1-pentene, 1-hexene, 2-methyl-1-propene, 3-methyl-1-pentene, 4-methyl-1-pentene, and 5-methyl-1-hexene, as well as ethylene, butylene, and propylene, with the homopolymer of propylene being preferred. Polypropylene has thermoplastic properties best explained by a recitation of the following mechanical and physical properties: a rigid semi-crystalline polymer with a modulus of about 300 MPa to about 1 GPa, a yield stress of about 5 MPa to about 35 MPa, and an elongation to ranging from about 10% to about 1,000%.

Selection of a polyolefin from commercial producers uses Melt Flow Rate (MFR) properties. The MFR can range from about 0.05 to about 1400, and preferably from about 0.5 to about 70 g/10 min at 230° C. under a 2.16 kg load. For polypropylene, that MFR should be from about 0.5 to about 70 and preferably from about 1 to about 35 g/10 min at 23° C. under a 2.16 kg load.

Non-limiting examples of polypropylenes useful for the present invention are those commercially available from suppliers such as Dow Chemicals, Huntsman Chemicals, Formosa, Phillips, ExxonMobil Chemicals, Basell Polyolefins, and BP Amoco.

Any suitable elastomer can form the elastomeric phase of TPEs of the invention. It is preferred that the elastomer has a substantially saturated hydrocarbon backbone chain that causes the copolymer to be relatively inert to ozone attack and oxidative degradation, but that the elastomer also has side-chain unsaturation available for curing.

Examples of suitable elastomers include natural rubber, polyisoprene rubber, styrenic copolymer elastomers (i.e., those elastomers derived from styrene WO 2005/123829 PCT/US2005/020613 and at least one other monomer, elastomers that include styrene-butadiene (SB) rubber, styrene-butadiene-styrene (SBS) rubber, styrene-ethylene-butadiene-styrene (SEBS) rubber, styrene-ethylene-ethylene-styrene (SEES) rubber, styrene-ethylene-propylene-styrene (SEPS) rubber, styrene-isoprene-styrene (SIS) rubber, styrene-isoprene-butadiene-styrene (SIBS) rubber, styrene-ethylene-propylene-styrene (SEPS) rubber, styrene-ethylene-ethylene-propylene-styrene (SEEPS) rubber, styrene propylene-styrene (SPS) rubber, and others, all of which may optionally be hydrogenated), polybutadiene rubber, nitrile rubber, butyl rubber, and olefinic elastomer such as ethylene-propylene-diene rubber (EPDM) and ethylene-octene copolymers are non-limiting examples of useful elastomers according to the invention. Especially preferred are styrenic copolymer elastomers (e.g., rubbers such as SIBS, SEBS, SBS, SEPS, and SEES, et cetera); nitrile rubber; butyl rubber; and olefinic elastomers.

Particularly preferred are olefinic elastomers, especially EPDM, where the EPDM may be crosslinked partially or fully. Olefinic elastomers are especially useful in TPE-Os because of their reasonable cost for properties desired. Of these elastomers, EPDM is preferred because it is a fundamental building block in polymer science and engineering due to its low cost and high volume, as it is a commodity synthetic rubber since it is based on petrochemical production. EPDM encompasses copolymers of ethylene, propylene, and at least one nonconjugated diene. Most preferably, when EPDM comprises the elastomer phase of a TPE, the EPDM is crosslinked such that the TPE is a TPV. The benefits of using EPDM are best explained by the following mechanical and physical properties: low compression set, the ability to be oil extended to a broad range of hardness, and good thermal stability.

Selection of an olefinic elastomer from commercial producers uses Mooney Viscosity properties. The Mooney Viscosity for olefinic elastomer can range from about 1 to about 1,000, and preferably from about 20 to about 150 ML 1+4@100° C. For EPDM, that Mooney Viscosity should be from about 1 to about 200, and preferably from about 20 to 70 ML 1+4@100° C., when the elastomer is extended with oil. Non-limiting examples of EPDM useful for the present invention are those commercially available from multinational companies such as Bayer Polymers, DuPont Dow Elastomers, Uniroyal Chemicals (now part of Crompton Corp.), ExxonMobil Chemicals, DSM, Kumho, Mitsui, and others.

The elastomer itself may be provided in a variety of forms. For example, elastomers are available in liquid, powder, bale, shredded, or pelleted form. The form in which the elastomer is supplied influences the type of processing equipment and parameters needed to form the TPE. Those of ordinary skill in the art are readily familiar with processing elastomers in these various forms and will make the appropriate selections to arrive at the TPE component of the invention.

High Molecular Weight Polydialkylsiloxane

TPE compositions of the invention include a minor amount of at least one high molecular weight polydialkylsiloxane. The following general formula (I) is representative of a variety of polydialkylsiloxanes:
R⁵O—[Si(R⁶)₂—O]ₙR⁵ (I)
wherein n is an integer from about 2 to about 500,000, each R⁵ is independently a hydrogen or an alkyl or aryl moiety, and each R⁶ is independently an alkyl group, preferably each being the same alkyl group. Any suitable high molecular weight polydialkylsiloxane, as described herein, can be used in the present invention.

The hydrocarbon groups within each polydialkylsiloxane of this formula may be substituted with one or more heteroatoms or functional groups as known to those of skill in the art. Preferably, however, the polydialkylsiloxane is non-substituted and/or non-polar to minimize its tendency to migrate from the bulk composition to its surface.

The alkyl groups in polydialkylsiloxanes of the invention may be branched or straight-chained. Typically, for example in formula (I), the R⁶ alkyl groups have 1 to about 10 carbon atoms each. More preferably the R⁶ alkyl groups within polydialkylsiloxanes of the invention are relatively short in chain length, containing about 2 to about 4 carbon atoms. For example, suitable polydialkylsiloxanes for use herein include polydimethylsiloxanes (PDMS), polydiethylsiloxanes (PDES), polydipropylsiloxanes (PDPS), polydibutylsiloxanes (PDBS) and the like with polydimethylsiloxanes being preferred. Polydimethylsiloxane (PDMS) is widely available.

One particular kind of high molecular weight polydialkylsiloxane used in this invention is often referred to as “silicone gum” or “ultra high molecular weight silicone.” For example, Dow Corning Corporation of Midland, Mich., supplies a variety of these silicone gums under the Dow Corning™ “MB” trade designation.

Silicone gum,is often found in “masterbatch” form as a polydialkylsiloxane polymer dispersed in another polymer such as polypropylene or polyethylene. While many different weight ratios of the masterbatch components can be utilized, typically the polydialkylsiloxane polymer and other components each comprise about 50 percent by weight of the masterbatch composition. Silicone gum of this kind is available in a masterbatch form from the Dow Corning Corporation, of Midland Michigan, under the product designations “MB50-001” and “MB50-002.” A high molecular weight functionalized polydialkylsiloxane polymer dispersed in high impact polystyrene is available in a masterbatch form from Dow Corning under the product designation “MB25-504.”

Other commercial suppliers, such as for example, the Polybatch™ division of A. Schulman and Rhone-Poulenc businesses may also be contacted for similar compounds. Also useable are specialized PDMS materials, such as those having bio-compatibility and described at www.bionicsurfaces.de.

Polydialkylsiloxanes of lower molecular weight do not provide the improved scratch and mar resistance seen in those compositions prepared according to the invention. Further, lower molecular weight polydialkylsiloxanes have an undesirable tendency to exude to a composition's surface, particularly when the composition or article prepared therefrom is subjected to heat. Still further, the incorporation of lower molecular weight polydialkylsiloxanes may impair the structural integrity and strength of resulting articles.

Thus, it is preferred that if lower molecular weight polydialkylsiloxanes (i.e., those having a melt viscosity of 1,000,000 centistokes or less when measured at 25° C.) are present in compositions of the invention, they are present in amounts of less than 0.5 parts by weight, more preferably less than about 0.3 parts by weight, and most preferably less than about 0.1 parts by weight.

High molecular weight polydialkylsiloxanes are beneficially included within the composition in minor amounts. Preferably, TPE compositions of the invention comprise about 0.2% to about 10% and more preferably about 0.2% to about 5% based on weight of the TPE composition high molecular weight polydialkysiloxane.

Fluoropolymer

A wide variety of fluoropolymers are known to those skilled in the art. Any suitable fluoropolymer may be used in a minor amount to obtain durable and low friction TPE compositions of the present invention. For optimum effectiveness, preferably, about 0.01% to about 15%, more preferably about 0.05% to about 10%, and most preferably about 0.05% to about 2%, based on weight of the TPE composition comprises a fluoropolymer.

One particularly preferred fluoropolymer is polytetrafluoroethylene (PTFE). PTFE is widely available from many commercial sources.

PTFE is also preparable, for example, by polymerization of tetrafluoroethylene in an aqueous suspension or dispersion. This first step is followed by subjecting the resulting polytetrafluoroethylene to beta or gamma radiation of intensity between about 5 to about 50 MegaRads to reduce its molecular weight and thereby produce a waxy product. The radiation may be supplied, for example, by an electron beam radiation source or by a gamma radiation (e.g., cobalt 60) source. The particles are then preferably subdivided into a fine powder (preferably not over about 20 microns in average diameter, and most preferably not over about 10 microns in average diameter) by air milling or mechanical milling procedures. The melt index of preferred resulting PTFEs is about 0.1 to 100, and most preferably about 1 to about 5, grams per 10 minutes at 360° C. and a 2,160 gram load as measured according to ASTM D-1238-73.

It is preferred that the fluoropolymer be added to the TPE composition in a powdered form if the melting temperature of the fluoropolymer is higher than the processing temperature used to compound or prepare the TPE. If, on the other hand, the melting temperature of the fluoropolymer is below the processing temperature of the TPE, then the fluoropolymer need not necessarily be in a powdered form for optimum effectiveness. Often, fluoropolymer powders are characterized according to ASTM D5675-04 and ISO 12086-1.

Examples of fluoropolymers suitable for use in the invention include, but are not limited to, those supplied under the following trade designations: “DL-1” from Dry Lube Inc., “Teflon” from DuPont, “Viton” from DuPont Dow Elastomers, “Kynar” from Atofina, “Dynamar” from Minnesota Mining and Manufacturing Co., “Algoflon” from Ausimont, and “Fluon,” “Aflon,” and “Aflas,” from AG Fluoropolymers.

Optional Processing Oil

The use of processing oils to effect oil extension of the elastomeric phase in TPEs is well known in the art. In the production of TPEs, for example, it is often desirable to include an oil to extend the elastomeric phase of the composition. This oil extension provides the properties of lower hardness and better compression set while reducing cost of the elastomer to achieve the same volume. Oil can be a separate ingredient in the final TPE composition or it can be a part of the elastomer component used to prepare the base TPE component itself, depending on the commercial source of elastomer supply.

The selection of any processing oil used depends upon the specific elastomer being extended thereby. Non-limiting examples of oils suitable for optional use in the present invention include aromatic, paraffinic, and naphthenic mineral and silicone oils. Concentration of oil in the TPE composition will generally range from about 0 to about 300 phr, and preferably from about 0 to about 150 phr, based on weight of the base TPE, with the understanding that the actual amount used may vary and fall outside of these ranges as understood by those of ordinary skill in the art.

Optional Compatibilizer

A compatibilizer can optionally be used as a component of TPE compositions prepared according to the present invention. When selected accordingly, the compatibilizer can diffuse into the elastomeric phase of the TPE when in a molten state. With subsequent crystallization upon cooling, the compatibilizer links domains of cured elastomer particles dispersed in a thermoplastic matrix or vice versa. In the production of TPEs, for example, it is often desirable and advantageous to include a compatibilizer to promote synergistic integration of the two distinct components—the thermoplastic and elastomer—when attempting to provide certain improved performance properties as compared to those observed with either component alone.

When used in preparing TPE-Os, for example, a minor amount of a copolymer compatibilizer (relative to the olefinic elastomer) can effectively and further compatibilize an otherwise compatible TPE system. Desirably, the minor weight percentage ranges from about 0.5 to about 10, and preferably from about 1 to about 5.0 based on total weight of the TPE composition. Expressed alternatively in parts per hundred of rubber (“phr”), the minor amount of compatibilizer ranges from about 0.5 to about 50 phr, and preferably, from about 1.0 to about 10 phr based on weight of the base TPE component, the exact amount depending on the type of elastomeric phase present in the TPE.

Preferably, when used, copolymer compatibilizers are selected from olefinic and styrenic copolymers, such as ethylene styrene copolymers; extended polyolefin technology copolymers; ethylene alpha olefin copolymers; styrenic block copolymers, such as styrene ethylene butylene styrene; ethylene acrylate copolymers; ethylene vinyl acetate copolymers; and combinations thereof. The copolymers can be random, pseudo-random, block, or any other suitable form in structure.

Other Optional Additives

Any suitable additive may be included in desired amounts in TPE compositions of the invention. For example, fillers (e.g., calcined clay, kaolin clay, talc, silicates, and carbonates), pigments and colorants (e.g., carbon black), flame retardants, antioxidants, conductive particles, UV-inhibitors, stabilizers, coupling agents (e.g., silanes, maleated polyolefins, zirconates and titanates), plasticizers, other lubricants, antiblocking agents, antistatic agents, waxes, foaming agents, and combinations thereof may be beneficially used in certain applications. Those of ordinary skill in the art will readily understand selection and use of such additives. It is preferred, however, that any optional additives employed do not significantly counteract the benefits otherwise observed with compositions of the invention. Further, as noted, the compositions of the invention enable preparation of suitable TPE compositions without requiring the use of conventional fillers used to improve scratch and mar resistance of compositions—many of which undesirably increase the composition's hardness to the extent that it is unusable for the intended application.

Selection And Processing Of TPE Compositions

Preferably, within the TPE compositions of the invention, the thermoplastic and elastomer components of base TPE are selected such that they are generally compatible. The phrase “generally compatible” means that the cured elastomeric phase of the TPE has good adhesion to, and is finely dispersed in, a continuous thermoplastic phase. The average particle size in the dispersed phase can range from as small as physically possible to about 10 μm in diameter. Desirably, the particle size of the dispersed phase can range from about 0.1 μm to about 5 μm in diameter, and preferably from about 0.1 μm to about 2 μm in diameter in particularly preferred TPE systems:

If the dispersion does not meet that expected or desired for a certain application, and particularly if the thermoplastic and elastomer components in a TPE being prepared are generally incompatible, a compatibilizer may be added to the composition during compounding.

The ratio of thermoplastic to elastomer components in the base TPE varies depending on the intended application. Depending on the volume ratio and viscosity of the components, either the thermoplastic or elastomer can constitute the continuous (matrix) phase or the discontinuous (dispersed) phase of the TPE. The selection of the types and amounts of these components is understood by those of ordinary skill in the art.

The ratio of thermoplastic to elastomer components can vary anywhere generally between about 5 to 95 to about 95 to 5 based on parts by weight, depending upon the end properties desired. The type and amount of each of the thermoplastic and elastomer components are selected such that they contribute to achieving desired properties in the TPE compositions.

To a base TPE, a minor amount of at least one high molecular weight polydialkysiloxane and a minor amount of at least one fluoropolymer are added to form a blended TPE composition. The combination of at least one high molecular weight polydialkylsiloxane and at least one fluoropolymer is preferably in the range of about 0.5% to about 50%, more preferably about 0.5% to about 30%, and most preferably about 1% to about 10%, based on total weight of TPE composition. It is the unique blend of components that provides improved TPE compositions exhibiting both durability and low friction for extended usefulness of TPEs.

Processing of the TPE composition can occur via batch or continuous processing. Using either batch or continuous processing, components of the composition can be mixed (and optionally heated to react when, for example, at least partially vulcanization of the elastomer is desired) in a single piece of equipment. Alternatively, the components can be mixed (and optionally heated to vulcanize the elastomer and/or process the composition into the desired shape and size) in multiple pieces of equipment. Economies of scale for production lead to a preference for continuous processing, whereby the compositions can be formed into desired shapes and sizes continuously with their preparation.

In one embodiment of a batch process, the compositions can be prepared by mixing the components in a first piece of equipment. Mechanical mixers, such as Banbury-type, Brabender-type, roll mill, dry turbo mixers and the like are suitable for this purpose.

For example, all base TPE components (i.e., elastomer and thermoplastic) of the composition can be charged into the mixer at a temperature ranging from about 170° C. to about 210° C., and preferably from about 175° C. to about 185° C. Mixing proceeds at a pace ranging from about 10 to about 100 rpm (revolutions per minute), and preferably from about 75 to about 85 rpm for a duration ranging from about 1 to about 5 minutes, and preferably from about 2 to about 4 minutes.

Thereafter, a minor amount of high molecular weight polydialkylsiloxane and a minor, amount of fluoropolymer are added either sequentially or simultaneously. The mixture is then allowed to mix for an additional period of time, ranging from about 1 to about 10, and preferably from about 6 to about 8, minutes. The composition is then transferred to other equipment for formation into the desired shape and size. For example, plugs of the TPE composition can be removed from the mixer and compression-molded into, for example, a 7.6×15.2×0.31 cm (3×6×0.125 inch) plaque mold at a temperature ranging from about 170° C. to about 210° C., and preferably from about 175° C. to about 185° C. The plug material can be held under no pressure for 30 seconds, after which time pressure can be increased to 1,100 kN force over a period of about 3 minutes. After application of pressure of 1,100 kN force for 4 minutes, the samples can be cooled to ambient temperature while pressure is maintained.

During continuous processing, the base TPE components (i.e., the elastomer and thermoplastic) can be first mixed in a suitable mixer without substantial application of heat. Mechanical mixers, such as Banbury-type, Brabender-type, roll mill, Buss co-kneader, dry turbo mixers and the like are suitable for this purpose. In this embodiment, the mixed components are then conveyed continuously to another piece of equipment, where the mixture is heated to at least partially vulcanize the elastomer within the composition. For example, reactive extrusion equipment is suitable for this purpose.

Reactive extrusion allows for dynamic vulcanization to occur, which is preferable when preparing TPVs. Dynamic vulcanization can advantageously reduce processing time and throughput. However, methods other than dynamic vulcanization can be utilized to prepare compositions of the invention when it is desired for the elastomer to be at least partially vulcanized. For example, the elastomer can be vulcanized in the absence of the thermoplastic, powdered, and mixed with the thermoplastic at a temperature above the melting or softening point of the thermoplastic to form a TPV.

A wide variety of reactive extrusion equipment can be employed for processing the mixture. Preferred is a twin screw co-rotating extruder with a length-to-diameter (L/D) ratio ranging from about 24 to about 84, and preferably from about 32 to about 64. Utilization of relatively low L/D ratio (e.g., 44 or less) extruders is possible, advantageously, with certain preferred embodiments of the invention.

To achieve vulcanization of the elastomer within the composition, the mixture is typically heated to a temperature substantially equal to or greater then the softening point of any thermoplastic employed and for a sufficient time to obtain a composition of the desired homogeneity and crosslinking of the rubber or elastomer. For example, the extrusion profile for a preferred PP/EPDM reactive extrusion can be a flat 180° C. profile and 300 rpm. The components can be fed into the reaction extruder at 27 kg/hr (60 lb/hr) using, for example, a 25-mm twin screw extruder. Lower rates may be used, for example, where the residence time needs to be higher in order to complete the degree of vulcanization desired. The actual rate and residence times needed are dependent upon the total amount of elastomer, the type of elastomer, the type and amount of curative (if used), as well as the L/D of the extruder and the precise screw design and configuration.

The components of the overall TPE composition may be added to the processing equipment in any suitable amount and in any suitable order. Preferably, however, the base TPE (or the elastomer and thermoplastic components from which it is derived) is generally added to the processing equipment prior to addition of the high molecular weight polydialkysiloxane and fluoropolymer components. Further, if used and if the TPE is prepared in-situ, a suitable amount of processing oil (e.g., mineral oil and the like) is preferably added to the elastomer prior to addition of the thermoplastic to adjust the hardness of the TPE. For example, the thermoplastic is preferably mixed with the elastomer and processing oil, if used, prior to addition of the high molecular weight polydialkylsiloxane and fluoropolymer.

The high molecular weight polydialkylsiloxane, fluoropolymer, and other additives are generally added after addition of the foregoing components. The high molecular weight polydialkylsiloxane and fluoropolymer, however, are preferably added to the composition prior to addition of other additives, including any additives used to effect vulcanization of the elastomer. When using additives for vulcanization, those components may be added, preheated and injected, directly into a melt stream of the previously added components or into the main hopper where the components reside in a premixed state.

Those of skill in the art are readily able to adapt conventional TPE processing equipment and methods to incorporate minor amounts of high molecular weight polydialkylsiloxanes and fluoropolymers into TPE compositions according to the invention. Many variations to those exemplified preparation methods set forth above are possible and well within the knowledge of those of ordinary skill in the art of TPE compounding and preparation.

Usefulness

Preferably, the durability and lubricity of the TPE composition is improved, as compared to the same TPE composition without the addition of the high molecular weight polydialkylsiloxane and fluoropolymer combination.

Depending on the application and individual's preference, one or more of the following methods can be used to detect whether there is an improvement in a composition's durability, a feature found with TPE compositions of the invention.

According to the following methods, ASTM T-bars, conditioned at 23° C. and 50% relative humidity for 48 to 96 hours, can be used to prepare molding plaques for testing. Extruded T-bar pellets are dried at about 80° C. (175° F.) for a minimum of one hour, but usually overnight. Molded plaques of the desired dimensions are then formed from the pellets. After molding, the plaques are aged at ambient temperature and humidity for at least 48 hours before testing.

Five Finger Ford Test Method (described in U.S. Pat. No. 6,177,515)

Scratch and mar resistance is measured using Ford Laboratory Test Method BN 108-13 (resistance to scratching). The apparatus employed includes several weighted pins resting on the surface of a black-pigmented test specimen. “Gloss Readings” are taken with a 20-degree gloss meter from a smooth (i.e., ungrained) sample.

The pins used for the scratch test are 1.0-mm diameter highly polished steel balls and the pins used for the mar test are 7.0-mm diameter balls. The pins are loaded with different weights exerting the following respective standard forces on the surface of the test material: 7.0 Newtons (N); 6.0 N; 3.0 N; 2.0 N; and 0.6 N and then each is pulled along the plaque being tested.

All scratch lines are examined and evaluated against a control specimen according to a rating scale of 1 to 5, where a rating of “1” is assigned to those specimens exhibiting no scratch line at all and a rating of “5” is assigned to those specimens exhibiting severe scratching. Preferably, TPE compositions of the invention have a Gloss Reading of less than about 3, and more preferably less than about 2, when evaluated according to this method.

Chrysler Crocking Gloss Test Method

This test for scratch and mar resistance is carried out according to Chrysler laboratory procedure LP-463PB-54-01 using an Atlas AATCC Mar Tester, Model CM-5 (available from Atlas Electric Devices Co.). Cleanser is applied to half of a 10-cm by 15-cm (4-inch by 6-inch) molded plaque. The cylindrical, acrylic finger on the Mar Tester is covered with a 5-cm by 5-cm (2-inch by 2-inch) piece of 14-9956-000 green felt cloth commercially available from Atlas Electric Devices Co.

The cleanser-coated plaque is rubbed with a wool cloth ten times (ten double strokes) to provide marred areas on the plaque. A 20-degree gloss value is measured at several places on the marred and umnarred areas of the plaque. The maximum gloss value on the unmarred area is referred to as the original gloss. The minimum gloss value on the marred area is referred to as the marred gloss.

The “Percent Gloss Retention,” or mar resistance, is calculated from the marred gloss value divided by the original gloss value times 100. Preferably, TPE compositions of the invention have a Percent Gloss Retention of at least about 50%, more preferably at least about 75%, when evaluated according to this method.

Ford Crocking Gloss Test Method

This test for scratch and mar resistance is carried out according to Ford laboratory test method BI 161-01, Mar Resistance Determination for Automotive Coatings, using an Atlas AATCC Mar Tester, Model CM-5 (available from Atlas Electric Devices Co.). A 50-mm by 50-mm square of 281Q Wetordry™ production polishing paper, commercially available from Minnesota Mining and Manufacturing Company (3-μm grade, rather than the standard 2-μm grade), is placed over a similar size square of 14-9956-000 green felt, commercially available from Atlas Electric Devices Co., with the abrasive side of the polishing paper facing outward. The mar tester has a cylindrical acrylic, brass or wooden finger 16 mm in diameter and exerts a force of 9 N on the test surface using a stroke of approximately 100 mm. The two squares of polishing paper and felt are mounted over the finger of the mar tester, with the felt positioned between the finger and the polishing paper.

An initial 20-degree gloss value is determined, after which the plaque surface being tested is subjected to 10 double strokes of the mar tester. The 20-degree gloss value of the abraded area is then measured in a direction parallel to the rubbing stroke of the mar tester. The lowest measured value is recorded.

The “Percent Gloss Retention,” or mar resistance, is calculated from the 20-degree gloss of the abraded area of the plaque divided by the initial 20-degree gloss value times 100. Preferably, TPE compositions of the invention have a Percent Gloss Retention of at least about 50%, more preferably at least about 75%, when evaluated according to this method.

Taber Abrasion Test Method

This test for abrasion is carried out according to ASTM F1478-95(2000) adapted for plastic and TPE films and sheets.

ASTM Abrasion Test Method

This test for abrasion is carried out according to ASTM D1242-95a.

Preferably, the friction of the TPE composition is also lowered as compared to the same TPE composition without the addition of the high molecular weight polydialkylsiloxane and fluoropolymer combination. Depending on the application and individual's preference, ASTM D 1894-1 can be used to detect whether there is an improvement in a composition's friction, a feature found with TPE compositions of the invention where low friction (i.e., as measured by the coefficient of friction of the TPE composition) is desired.

### EXAMPLES

Further embodiments of the invention are described in the following non-limiting examples.

The coefficient of friction (COF) values reported in the tables below are those measured according to ASTM D 1894-1.

The abrasion resistance values reported in the tables below are those measured qualitatively. Qualitative abrasion testing was performed using finger nail scratches and subjective evaluation of whether the scratched sample exhibited poor, fair, good, very good, or excellent resistance to scratching.

Within the following specific examples, the following components (for which a source and trade designation, if applicable, are provided in Table 1) are utilized:

TABLE 1

| (Trade Designation) | |
|---|---|
| Component | Supplier |
| (Anox ™ BB 011) | Great Lakes Chemical Corp.; |
| A hindered phenolic antioxidant/phosphite | Indianapolis, IN |
| blend | |
| (Anox ™ BB 011/Irganox ™ B 225) | Great Lakes Chemical Corp.; |
| A hindered phenolic antioxidant/phosphite | Indianapolis, IN/Ciba |
| blend | Specialty Chemicals; |
| | Tarrytown, NY |
| Citric Acid | Vopak USA; |
| | Houston, TX |
| (Dow Corning ™ MB50-001 Masterbatch) | Dow Corning; |
| Ultra high molecular weight siloxane | Midland, MI |
| polymer dispersed in polypropylene | |
| homopolymer | |
| (Forprene ™ EK5 001 A65) | PolyOne Corp.; |
| TPE having a polyolefin phase with a | Avon Lake, OH |
| crosslinked EPDM phase dispersed therein | |
| (Forprene ™ 6K5 901 A75) | PolyOne Corp.; |
| TPE having a polyolefin phase with a | Avon Lake, OH |
| crosslinked EPDM phase dispersed therein | |
| (Hifax ™ CA 10 A) | Basell; |
| Thermoplastic olefin | Elkton, MD |
| (Kraton ™ G-1652) | Kraton Polymers; Houston, |
| SEBS | TX |
| (Lowilite ™ 26/Tinuvin ™ 326) | Great Lakes Chemical Corp.; |
| An ultraviolet stabilizer of the | Indianapolis, IN/Ciba |
| benzatriozole family | Specialty Chemicals; |
| | Tarrytown, NY |
| (Lowilite ™ 55) | Great Lakes Chemical Corp.; |
| An ultraviolet light absorber belonging to | Indianapolis, IN |
| the benzotriazole class | |
| (Lowinox ™ MD24) | Great Lakes Chemical Corp.; |
| A metal deactivator that additionally acts | Indianapolis, IN |
| as a hindered phenolic antioxidant | |
| Magnesium Chloride | Magnesium Products; Tulsa, |
| | OK |
| (Nordel ™ IP 4770P) | DuPont Dow Elastomers, |
| EPDM | L.L.C.; Wilmington, DE |
| (Pro-fax ™ 6823) | Basell; |
| Polypropylene homopolymer, 1 MFR | Elkton, MD |
| (Pro-fax ™ PDC 1272) | Basell; |
| Polypropylene homopolymer, 0.5 MFR | Elkton, MD |
| PTFE DL-1 | Dry Lube Inc. |
| A fluoropolymer in powder form | |
| (SP-1045) | Schenectady International, |
| An octophenyl heat reactive curative | Inc.; Schenectady, NY |
| Stearic Acid | Cognis Corp.; |
| | Cincinnati, OH |
| (Lowilite ™ 55/Tinuvin ™ P) | Great Lakes Chemical Corp.; |
| An ultraviolet light absorber belonging to | Indianapolis, IN/Ciba |
| the benzotriazole class | Specialty Chemicals; |
| | Tarrytown, NY |
| White Kaolin Clay | Kentucky-Tennessee Clay |
| | Co., a member of Imerys; |
| | Nashville, TN |
| Zinc Oxide | Zinc Corp. of America; |
| | Monaca, PA |
| Zinc Stearate | Crompton Corp.; Greenwich, |
| | CT |
| Titanium Dioxide | Millennium Chemicals; |
| Pure R101 | Hunt Valley, MD |
| (Hydrobrite ™ 550 PO) | Crompton Corp.; Greenwich, |
| White paraffin oil, which was preheated to | CT |
| about 100° C. | |

### Examples 1-3 and Comparative Examples C1-C3

Components, and their respective amounts, utilized in these examples are listed in Table 2. First, a commercially available TPE was selected for use. Then, a high molecular weight polydialkylsiloxane in a masterbatch pellet form and a PTFE powder were selected in types and amounts to provide the desired improvement in scratch and mar resistance and reduction in friction.

The components in each example were added into the hopper of a Prism™ 16-mm twin screw extruder (available through Thermo Electron Corporation; Waltham, Mass.) and compounded at a melt temperature of about 195° C. (385° F.). The compounded pellets were then dried at about 85° C. (185° F.) and extruded with a 3.8-cm (1.5-in)-diamoter “Killion” single screw extruder (available through Davis-Standard in the Crompton family of businesses) through a sheet die that was about 10 cm (4 in) wide and 0.3 cm ( 1/16 in) thick into a sheet about 9.5 cm (3.75 in) wide. Each sheet was cut into 5-cm×5-cm (2-in×2-in) squares and measured to determine its initial coefficient of friction (COF). The sheet samples were also cut into specimens suitable for abrasion testing.

The test results obtained are shown in Table 2:

TABLE 2

| | Parts by Weight | | | | | |
|---|---|---|---|---|---|---|
| Component | Ex. 1 | Ex. 2 | Ex. 3 | Ex. C1 | Ex. C2 | Ex. C3 |
| Forprene ™ | 47.95 | 46.95 | 46.90 | 50.00 | 48.00 | 47.00 |
| EK5 001 A65 | | | | | | |
| Forprene ™ | 47.95 | 46.95 | 46.90 | 50.00 | 48.00 | 47.00 |
| 6K5 901 A75 | | | | | | |
| Dow Corning ™ | 4.00 | 6.00 | 6.00 | — | 4.00 | 6.00 |
| MB50-001 | | | | | | |
| Masterbatch | | | | | | |
| PTFE DL-1 | 0.10 | 0.10 | 0.20 | — | — | — |
| COF Value (Best) | 0.420 | 0.347 | N/A | 0.538 | 0.529 | 0.450 |
| COF Value | 0.452 | 0.412 | N/A | 0.551 | 0.545 | 0.475 |
| (Average) | | | | | | |
| Abrasion | Good | Good | Very | Poor | Fair | Fair |
| Resistance | | | Good | | | |

As evidenced by the data shown in Table 2, compositions containing both a high molecular weight polydialkylsiloxane and fluoropolymer according to the invention exhibit marked lowering in their coefficient of friction. For example, adding as minor of an amount as 0.10 parts by weight of a fluoropolymer in Example 1 provides a lowering of approximately 0.1 in the COF of a similar composition without the fluoropolymer—Comparative Example C2. Further, those compositions of the invention also exhibited better abrasion resistance than the comparative examples that did not contain the fluoropolymer component.

### Examples 4-9 and Comparative Examples C4-C6

A base TPE-O component for each of these examples was prepared in pellet form by mixing the components and amounts thereof listed in Table 3 in a Banbury-type mixer. The components were each dropped at 175° C. (350° F.) into a heated roll mill and formed into strips that were fed into a single screw extruder fitted with an underwater pelletizer. Pellets of the base TPE-O component were thus formed.

TABLE 3

| Component | % by wt. |
|---|---|
| Nordel ™ IP 4770P | 25.00 |
| Pro-fax ™ 6823 | 10.00 |
| Kraton ™ G-1652 | 3.00 |
| Hifax ™ CA 10 A | 9.00 |
| White Kaolin Clay | 9.50 |
| Zinc Oxide | 2.20 |
| Zinc Stearate | 0.13 |
| Citric Acid | 1.00 |
| Stearic Acid | 0.25 |
| Anox ™ BB 011 | 0.20 |
| Lowilite ™ 55 | 0.20 |
| Titanium Dioxide | 0.60 |
| Magnesium Chloride | 3.00 |

These pellets were then used subsequently to make various TPV compositions using the components and amounts indicated in Table 4:

TABLE 4

| | Parts by Weight | | | | | | | |
|---|---|---|---|---|---|---|---|---|
| | | | | | | Ex. | Ex. | Ex. |
| Component | Ex. 4 | Ex. 5 | Ex. 6 | Ex. 7 | Ex. 8 | C4 | C5 | C6 |
| Base TPE-O | 90.80 | 90.80 | 90.80 | 90.80 | 85.50 | 90.80 | 90.80 | 90.80 |
| Pro-fax ™ PDC | 3.50 | 3.50 | 3.50 | 3.50 | 3.20 | 3.50 | 3.50 | 3.50 |
| 1272 | | | | | | | | |
| Lowilite ™ | 0.20 | 0.20 | 0.20 | 0.20 | 0.20 | 0.20 | 0.20 | 0.20 |
| 26/Tinuvin ™ 326 | | | | | | | | |
| Tinuvin P/ | 0.20 | 0.20 | 0.20 | 0.20 | 0.20 | 0.20 | 0.20 | 0.20 |
| Lowilite ™ 55 | | | | | | | | |
| Anox ™ BB | 0.10 | 0.10 | 0.10 | 0.10 | 0.10 | 0.10 | 0.10 | 0.10 |
| 011/Irganox ™ B | | | | | | | | |
| 225 | | | | | | | | |
| Lowinox ™ MD 24 | — | — | — | — | 0.10 | — | — | — |
| Citric Acid | 1.80 | 1.80 | 1.80 | 1.80 | 1.40 | 1.80 | 1.80 | 1.80 |
| Dow Corning ™ | 4.00 | 6.00 | 6.00 | 4.00 | 3.30 | — | 4.00 | 6.00 |
| MB50-001 | | | | | | | | |
| Masterbatch | | | | | | | | |
| Zinc Oxide | — | — | — | — | 1.00 | — | — | — |
| SP-1045 | 2.40 | 2.40 | 2.40 | 2.40 | 2.00 | 2.40 | 2.40 | 2.40 |
| PTFE DL-1 | 0.10 | 0.10 | 0.50 | 2.00 | 2.00 | — | — | — |
| Titanium Dioxide | 1.00 | 1.00 | 1.00 | 1.00 | 1.00 | 1.00 | 1.00 | 1.00 |
| COF Value (Best) | 0.482 | 0.468 | N/A | 0.479 | 0.502 | 0.817 | 0.606 | 0.453 |
| COF Value | 0.526 | 0.488 | N/A | 0.518 | 0.566 | 0.942 | 0.665 | 0.503 |
| (Average) | | | | | | | | |
| Abrasion Resistance | Good | Good | Very | Excellent | Excellent | Poor | Fair | Fair |
| | | | Good | | | | | |

As the data in Table 4 shows, the coefficient of friction is substantially reduced from the value of 0.942 obtained for the TPE with no addition of high molecular weight polydialkysiloxane or fluoropolymer (Comparative Example C4). As further noted by comparing Examples 4 and 5 with Comparative Examples C5 and C6, respectively, the unique combination of high molecular weight polydialkylsiloxane and fluoropolymer provided further reductions in the compositions friction as compared to those compositions prepared without the fluoropolymer. As also noted by comparing Examples 4 and 7, the addition of more fluoropolymer to a TPE composition already enhanced by the addition of high molecular weight polydialkysiloxane and fluoropolymer can provide further lowering of the material's friction. In addition, compositions of the invention also exhibited better abrasion resistance than the comparative examples in this set of examples.

Another set of experiments was run with higher levels of the polydialkylsiloxane and fluoropolymer and shown in Table 5 below:

TABLE 5

| | Parts by Weight | | | | | |
|---|---|---|---|---|---|---|
| Component | Ex. 9 | Ex. 10 | Ex. 11 | Ex. 12 | Ex. 13 | Ex. C7 |
| Forprene ™ | 46.75 | 46.50 | 46.00 | 45.00 | 44.00 | 50.00 |
| EK5 001 A65 | | | | | | |
| Forprene ™ | 46.75 | 46.50 | 46.00 | 45.00 | 44.00 | 50.00 |
| 6K5 901 A75 | | | | | | |
| Dow | 6.00 | 6.00 | 6.00 | 8.00 | 10.00 | 0.00 |
| Corning ™ | | | | | | |
| MB50-001 | | | | | | |
| Masterbatch | | | | | | |
| PTFE DL-1 | 0.50 | 1.00 | 2.00 | 2.00 | 2.00 | 0.00 |
| COF Value | 0.590 | 0.470 | 0.527 | 0.503 | 0.474 | 0.842 |
| (Best) | | | | | | |
| COF Value | 0.616 | 0.500 | 0.549 | 0.516 | 0.519 | 0.933 |
| (Average) | | | | | | |

| | | | | | |
|---|---|---|---|---|---|
| Abrasion | Very | Very | Very | Excellent | Poor |
| Resistance | Good | Good | Good | | |

Table 5 shows that, compared to the values of COF in Comparative Example C7, the COF values of this invention shown in Examples 9 through 13 also showed significant reduction.

Various modifications and alterations of the invention will become apparent to those skilled in the art without departing from the spirit and scope of the invention, which is defined by the accompanying claims.

What is claimed is:

1. A thermoplastic elastomer composition comprising:
at least one thermoplastic elastomer,
a minor amount of at least one high molecular weight polydialkylsiloxane, and
a minor amount of at least one fluoropolymer,
wherein the composition includes less than 0.5 parts by weight of polydialkylsiloxane having a melt viscosity of 1,000,000 centistokes or less when measured at 25° C.

2. The thermoplastic elastomer composition of claim 1, wherein the composition includes less than about 0.3 parts by weight of the composition of polydialkylsiloxane having a melt viscosity of 1,000,000 centistokes or less when measured at 25° C.

3. The thermoplastic elastomer composition of claim 1, wherein the composition has a coefficient of friction of less than 0.50 when measured according to ASTM D 1894-1.

4. The thermoplastic elastomer composition of claim 1, wherein the thermoplastic elastomer is a thermoplastic vulcanizate and wherein the high molecular weight polydialkylsiloxane comprises a polydialkylsiloxane of Formula I:
R⁵O—[Si(R⁶)₂—O]ₙR⁵ (I)
wherein n is an integer from about 2 to about 500,000, each R⁵ is independently a hydrogen or an alkyl or aryl moiety, and each R⁶ is independently an alkyl group.

5. The thermoplastic elastomer composition of claim 1, wherein the fluoropolymer comprises about 0.01% to about 15% of the composition based on weight and wherein the fluoropolymer comprises polytetrafluoroethylene.

6. The thermoplastic elastomer composition of claim 1, wherein the thermoplastic elastomer comprises a polyolefin or ethylene-propylene-diene rubber (EPDM).

7. The thermoplastic elastomer composition of claim 1, further comprising at least one of a processing oil, a compatibilizer, or other additive.

8. An article prepared from the thermoplastic elastomer composition of claim 1.

9. A method of improving scratch and mar resistance of a thermoplastic elastomer comprising incorporating a minor amount of at least one high molecular weight polydialkylsiloxane and a minor amount of at least one fluoropolymer therein, wherein no more less than 0.5 parts by weight of polydialkylsiloxane having a melt viscosity of 1,000,000 centistokes or less when measured at 25° C. is incorporated into the thermoplastic elastomer composition according to the method.

10. The method of claim 9, wherein scratch and mar resistance of the thermoplastic elastomer is improved when evaluated using at least one test method selected from Five Finger Ford Test Method, Chrysler Crocking Gloss Test Method, Ford Crocking Gloss Test Method, Taber Abrasion Test Method, and ASTM Abrasion Test Method.
